(19) United States
(12) Patent Application Publication
(10) Pub. No.: US 2024/0138029 A1
(43) Pub. Date: Apr. 25, 2024

(54) PTC Heating Device and Method of Manufacturing the Same

(71) Applicant: Eberspächer catem GmbH & Co. KG, Herxheim (DE)

(72) Inventors: Timo Kröner, Rülzheim (DE); Patrick Werner, Neuhofen (DE); Daniele Dattilo, Rhodt unter Rietburg (DE)

(21) Appl. No.: 18/381,900

(22) Filed: Oct. 18, 2023

(30) Foreign Application Priority Data
Oct. 20, 2022 (DE) 10 2022 127 875.1

(51) Int. Cl. H05B 3/26; B23K 20/00; B23K 20/10; F24H 9/1863

(52) U.S. Cl. CPC H05B 3/267; B23K 20/002; B23K 20/10; F24H 9/1872; F24H 2250/04; H05B 2203/016; H05B 2203/017; H05B 2203/02

(57) ABSTRACT

A PTC heating device has a frame surrounding an accommodation space, at least one PTC element accommodated in the accommodation space, and conductor elements, which are connected to the PTC element in an electrically conductive manner and enclose the PTC element between them. Each of the conductor elements is surrounded by a frame segment. The frame segments are welded together to enclose the PTC element in the accommodation space. In the method according to the invention, injection molded plastic frame segments having interacting connection segments are connected to conductor elements. At least one PTC element is then introduced between the frame segments. The frame segments are approached to each other until the connection segments abut against each other. The connection segments are then melted. As a result of this melting, the frame segments are approached further to each other until the conductor elements abut against the PTC element.

### BACKGROUND OF THE INVENTION

### 1. Field of the Invention

The present invention relates to a PTC heating device with a frame surrounding an accommodation space, at least one PTC element accommodated in the accommodation space, and conductor elements which are connected to the PTC element in an electrically conductive manner. The conductor elements enclose the PTC element between them. Each of the conductor elements is completely or partially circumferentially surrounded by the frame, namely by a frame segment which forms part of the frame.

### 2. Background of Related Art

A generic PTC heating device is known, for example, from EP 2 337 425 A1 or EP 1 872 986 A1.

PTC heating devices of the type introductorily mentioned—as well as the PTC heating device according to the present invention—are usually used in motor vehicles. They are used for heating components of an electric vehicle in the field of electromobility and/or for air conditioning the vehicle interior. For this purpose, the PTC heating device of the type introductorily mentioned is accommodated in an electrical heating device, which usually forms a circulation chamber and a connection chamber, wherein both chambers are separated from each other by a partition wall. In the connection chamber, the conductor elements of the several PTC heating devices of the electrical heating device are electrically connected. In the circulation chamber, the medium to be heated is heated. The medium can be gaseous or liquid. In such a generally known electrical heating device, the PTC heating device according to the present invention is preferably also installed. The corresponding electrical heating device is also known, for example, from EP 2 337 425 A1 or EP 1 872 986 A1.

With regard to a preferably effective operation, the PTC element should decouple the heat generated by it in equal parts and without major heat transfer resistances via two opposite, predominantly heat-dissipating outsides of the PTC heating device. For this purpose, it is known not to provide the outside of the PTC heating device with plastic or the like where the PTC element abuts the conductor elements with its main side surfaces. In other words, the frame together with the conductor elements exposed externally forms a housing for the PTC element. The heat generated by the PTC element is conducted by heat conduction directly through the conductor element to the outside of the PTC heating device. In particular for high-voltage applications, an insulating layer, for example a ceramic and/or plastic layer, can be provided on the outside. Corresponding insulating layers covering the outer surfaces of the conductor elements in each case prevent direct electrical contact between the conductor elements and the medium to be heated. The corresponding insulating layers can be the outer surface of a PTC heating device, the frame of which also joins the insulating layer. Such a PTC heating device can, for example, be inserted in the partition wall in a fluid-tight manner as a plug element and protrude into the circulation chamber of the heating device in the manner of a heating fin; cf. DE 20 2019 005 223 U1. Alternatively, the PTC heating device can also be inserted into a usually metallic receiving pocket, which is regularly connected in one piece with the partition wall of the above-mentioned heating device and protrudes into the circulation chamber in the manner of a heating fin, EP 1 872 986 A1. In this case, too, direct electrical contact between each of the conductor elements and the receiving pocket is to be avoided during operation with high voltage.

PTC elements have a considerable dimensional tolerance due to the manufacturing process. A PTC element, as used in the present invention, is typically a cuboid ceramic component having two opposing main side surfaces and circumferential end side surfaces. The main side surface is typically at least a factor of 5 larger than each of the end side surfaces. The main side surfaces are spaced apart from each other by the dimension referred to below as height. This height dimension can vary, which makes special measures necessary with regard to the configuration of the frame and the conductor elements held by it, in order to enable a solid electrical application of the conductor elements against the main side surfaces of the PTC element within the conceivable height tolerances in each case.

Thus, the aforementioned prior art EP 2 337 425 A1 proposes to provide two frame segments with interlocking sections that interact to enclose the PTC element such that the PTC heating device can be inserted into the receiving pocket as a pre-assembled unit. According to this prior art, the two frame segments are connected to each other by a film hinge. The frame segments are provided in a unitary component made of a soft elastic silicone.

According to another previously known solution according to EP 1 916 873 A1, an elastic sealing element is located between the frame segments, which can track the height tolerances of the PTC element within limits, while also sealing the accommodation space from the environment.

A similar configuration is known from EP 1 768 457 A1. According to this solution, a contact sheet forming the conductor element can be connected to the frame in a sealed manner by overmolding, whereas a contact sheet is placed on the opposite side, which is externally covered by an insulating layer, which in turn is supported on the frame with the interposition of a compressible seal. The frame is made in one piece. In this way, a sealing of the PTC element against the environment at least at the edges and also a compensation of height tolerances on the part of the PTC element are achieved. The position of the contact sheet can be adjusted within limits in the height direction via the compressible seal.

### SUMMARY

The underlying problem of the present invention is to provide a PTC heating device of the type introductorily mentioned, which meets the above requirements in an improved manner.

For this purpose, the PTC heating device according to the invention has a frame surrounding an accommodation space and including at least two frame segments, at least one PTC element accommodated in the accommodation space, and conductor elements which are connected to the PTC element in an electrically conductive manner and which enclose the PTC element between them. Each of the conductor elements is surrounded at least partially by at least one of the frame segments, and the frame segments are ultrasonically welded together to enclose the PTC element in the accommodation space.

As will be explained in more detail below, the present invention succeeds in compensating for the tolerance variations in the height direction of the PTC elements. However, the PTC heating device can be provided as a structural unit by welding the two frame segments together. Welding can be carried out for each PTC element of a PTC heating device in an adapted manner such that the conductor elements are abutted in a planar manner against the PTC element after the structural unit has been produced by welding.

The frame surrounds the PTC element circumferentially, regularly fully circumferentially. The conductor elements extend parallel to the main side surfaces of the PTC element. These are usually made of sheet metal. Each of the sheets forms a contact tongue protruding externally beyond the frame. According to this configuration, the PTC element in the accommodation space is completely covered with respect to the environment. The conductor elements cover the main side surfaces and regularly protrude beyond them. They are connected in the frame segments. The frame is usually made of plastic.

For this purpose, the frame may have two frame segments. In other words, in this further development, the frame consists of only one of these two frame segments. The frame segments can be of identical configuration. This simplifies the overall manufacturing process. In this context, the frame segments have interlocking connection segments which are welded to one another, in particular ultrasonically welded. Before the frame segments are joined, the connection segments are usually configured such that they space the frame segments apart from one another before welding. Frame contact surfaces that are opposite each other and are adjacent to each other in the joined state are accordingly provided at a distance from each other. The connection segments are configured such that they space apart the frame segments in a rather punctiform or linear manner prior to welding. Connection segments of both frame segments can be configured to taper towards each other. The connection segments can meet in a central parting plane of the frame segments. One connection segment may be configured as a pin, and the connection segment may be complementarily configured on the other frame segment is configured as a depression for receiving the free end of the pin.

In the solution according to the invention, welding usually takes place exclusively via the connection segments. As usual, welding is accompanied by the formation of melt of the plastic forming the frame segments, which plastic solidifies after welding and thus causes a material connection between the two frame segments. In the case of a connection segment in the form of a pin, a punctiform area is regularly melted on in the depression and between the depression and the free end of the pin, forming a kind of a punctual melt like a local droplet. During the melting process, the distance between the frame segments is reduced by fusing a base of the depression and/or the free end of the pin until the respective conductor elements of the frame segments abut against the PTC element in a planar manner. In other words, the height spacing the frame segments apart from one another before welding is melted down to such an extent that the frame segments with their conductor elements are connected to the PTC element in an electrically conductive manner and also with good heat-conducting properties.

A pin formed as a connection segment usually has a small extension in the width and length direction and a considerable extension in the height direction. The extension in terms of height of the pin is usually greater than the height of the PTC element. The pin is inserted into the depression before melting. The depression is dimensioned such that melt occurring in varying quantities due to the height tolerance of the PTC element remains safely in the depression and spreading of the melt, in particular in the direction of the PTC element, is prevented. Accordingly, the depression ensures that the melt generated during welding remains at the location provided for this purpose, i.e. within the depression. With regard to easy initialization of melt during ultrasonic welding, the pin may be formed with a pointed or tapered shape at its free end.

It is understood that, depending on the desired strength of the welded joint, multiple connection segments may be provided on one of the frame segments and complementary connection segments may be provided on the other of the frame segments. The connection segments may be distributed around the circumference of the PTC element and provided at a distance therefrom. The connection segments are generally located within the outer circumferential surface of the frame, however outside the accommodation space.

With regard to complete control of the melt forming during welding, it is provided in accordance with a possible further development of the invention that a web is formed adjacent to the connection segments on at least one of the frame segments. This web is located between the outer circumferential surface of the frame and usually externally limits the connection segments. The web prevents melt generated during welding from spilling over beyond the outer contour of the frame. The web usually protrudes beyond the inner contact surface of the conductor element of the corresponding frame segment, which inner contact surface is connected to the PTC element in good heat and electrically conductive fashion. The electrical contact is usually made by metallization on the main side surfaces of the PTC element, which is otherwise made of ceramic. This metallization is part of the PTC element and can be applied by sputtering, plasma spraying or screen printing.

The present invention furthermore proposes a relatively low-height PTC heating device which nevertheless exploits the advantage of producing frame segments with conductor elements provided thereon as a structural unit. The conductor elements are sealed to the frame segment by overmolding the conductor elements with the plastic forming the respective frame segment. The frame segments are therefore off-tool prepared in final contour and together with the associated conductor element. As mentioned above, two identical frame segments with corresponding identical conductor elements are usually produced to form a frame. Thus, the number of different components for producing the frame can remain low. Faulty assembly is also largely ruled out because the frame segments are provided complementary to each other. The same applies to the conductor elements. This also simplifies insertion into the injection mold for overmolding.

In a manner generally known, the conductor elements have a basically rectangular base surface which abuts the PTC element. This rectangular base surface can have the same dimensions as the main side surface of the PTC element, or it can slightly protrude beyond it. The contact tongue protrudes from the rectangular base surface. According to the present further development, at least one connecting web protrudes from the rectangular base surface, i.e. the otherwise straight edge of the conductor elements. Regularly, several connecting webs protrude from different edges of the one conductor element. These connecting webs are sealed into the frame segments. The connecting webs typically have connecting projections bent out of the plane of the sheet material for improved anchorage in the frame segment. These typically extend substantially perpendicular to the inner contact surface of the conductor element. In any case, the height of the frame is thickened where the connecting projections engage the frame. The frame here has positioning projections which cover the connecting webs. With regard to the lowest possible height of the individual frame segments, respective connecting projections are provided for and assigned to positioning projection receptacles on the respective other frame segment. The positioning projections protrude from the essentially planar frame contact surface. The positioning projection receptacles regularly recede from this frame contact surface. After the frame segments have been joined by welding, a corresponding positioning projection is located in its associated positioning projection receptacle of the other frame segment. This interlocking of the positioning projection and the positioning projection receptacle usually takes place only during welding, i.e. when the frame segments are approached during melting of the connection segments. In other words, the frame segments are not usually pre-positioned via the positioning projections and their holders.

A corresponding positioning projection may also be provided at a point where the contact tongue formed by the conductor element penetrates the frame to the outside. The corresponding contact tongue is accordingly guided through under a positioning projection of the frame. A correspondingly configured holder is provided for this positioning projection on the respective other frame segment.

In addition, bores can be provided on the conductor element which are penetrated by the plastic material of the frame segment during overmolding. The bores are usually configured to be conical on the outside. This results in a solidified melt plug as part of the frame segment after injection molding, which also holds the conductor element within the bore in a form-fitting manner.

Also disclosed is a method of forming a PTC heating device. The method includes injection-molding frame segments from a plastic so as to form interacting connection segments on the frame segments, connecting each of the frame segments to a conductor element, introducing at least one PTC element between the frame segments, approaching the frame segments to each other until the connection segments abut against each other. The method additionally includes melting the connection segments so as to allow the frame segments to further approach each other until the conductor elements abut against the PTC element.

The frame segments are optional if, for example, the conductor elements comprise a contact sheet. In this case, a PTC heating device may comprise a frame surrounding an accommodation space, at least one PTC element accommodated in the accommodation space, and conductor elements which are connected to the PTC element in an electrically conductive manner and which enclose the PTC element between them. Each of the conductor elements is sealed in the frame by overmolding a plastic forming the frame, and the conductor elements comprise connecting webs protruding from an edge, which connecting webs are covered by positioning projections which are formed on a portion of the frame and which cooperate with associated projection receptacles on another portion of the frame.

### BRIEF DESCRIPTION OF THE DRAWINGS

Further details and advantages of the present invention will be apparent from the following description of an embodiment in conjunction with the drawing. Therein:

FIG. 1 shows a perspective exploded view of the embodiment of the PTC heating device;

FIG. 2 shows a perspective top view of a frame segment of the embodiment according to FIG. 1;

FIG. 3 shows a perspective top view of the conductor element to the frame segment according to FIG. 2;

FIG. 4 shows a top view of the embodiment according to FIG. 2;

FIG. 5 shows a sectional view along line V-V according to the illustration in FIG. 4;

FIG. 6 shows a sectional view along line VI-VI according to FIG. 4;

FIG. 6A shows an enlarged detail at the top edge of FIG. 6;

FIG. 6B shows an enlarged detail at the bottom edge of FIG. 6;

FIG. 7 shows a perspective sectional view along line VII-VII according to the illustration in FIG. 4;

FIG. 8 shows a perspective sectional view along line VIII-VIII according to the illustration in FIG. 4;

FIG. 9A, 9B shows a perspective side view of a device for welding the PTC heating device according to the preceding embodiments in an initial position of a sonotrode (FIG. 9A) and an end position of the sonotrode (FIG. 9B).

### DETAILED DESCRIPTION

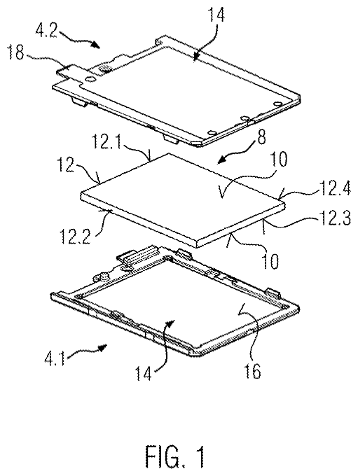

FIG. 1 shows an embodiment of a PTC heating device 2 with a two-part frame 4, formed by a first frame segment 4.1 and a second frame segment 4.2. The frame segments 4.1 and 4.2 are configured identically. Accordingly, they form frame halves. In the joined state, the frame segments 4.1 and 4.2 form the entire frame 4 and surround an accommodation space 6. A PTC element 8 is accommodated in this accommodation space. The PTC element 8 is provided as a semiconducting ceramic component with metallizations formed on main side surfaces 10 of the PTC element 8. Between the main side surfaces 10 of the PTC element 8, the latter forms a circumferential edge 12, the respective edge surfaces of which are characterized by reference signs 12.1-12.4.

Conductor elements characterized by reference sign 14 each form an inner contact surface 16 to the main side surfaces 10. The conductor elements 14 are made of sheet metal. The conductor elements 14 each form a contact tongue 18 by punching. Connecting webs formed by punching and bending are characterized by reference sign 20, each of which projects beyond a lateral edge of the rectangular contact surface 16 and has connecting projections 22 projecting from the plane of the contact surface 16 as a result of bending, which can be seen in particular in FIGS. 3 and 6A. The conductor elements 14 formed by metal sheets further have bores 24 recessed in the area of opposite edges (cf. FIG. 3).

The connecting webs 20 are each covered by a positioning projection 26 of the frame segment 4.1/4.1, wherein the positioning projection 26 also accommodates the connecting projection 22. The corresponding positioning projection 26 protrudes beyond a frame contact surface characterized by reference sign 28, which is substantially planar and runs around in a plane in the circumferential direction of frame segment 4.1/4.2. To accommodate a single positioning projection 26, the respective other frame segment 4.1 or 4.2 has positioning projection receptacles 30 extending from the frame contact surface 28.

Complementary projections 26 and holders 30 are provided on longitudinal beams 32 of the frame 4. On an upper cross beam 34, a continuous bore is arranged as a positioning projection receptacle 30 for the round positioning projection 26 provided there. The upper cross beam 34 has an angular recess 36 for holding a cuboid positioning projection 26, which covers the contact tongue 18 and seals in the same.

Due to the measures described above, the conductor element 14 is solidly connected to the respective frame segment 4.1/4.2. On the other hand, each frame segment 4.1/4.2 can be formed separately with a low height (distance from outer surface to frame contact surface 28). As FIG. 6B illustrates, as a result of the overmolding, the bore 24 is penetrated with melt in each case and solidifies there to form a conical melt plug 41. The bore 24 is conically shaped towards the outside, so that the melt plug 41 also causes a form-fit connection between the respective frame segment 4.1/4.2 and the conductor element 14 at the lower cross beam 34.

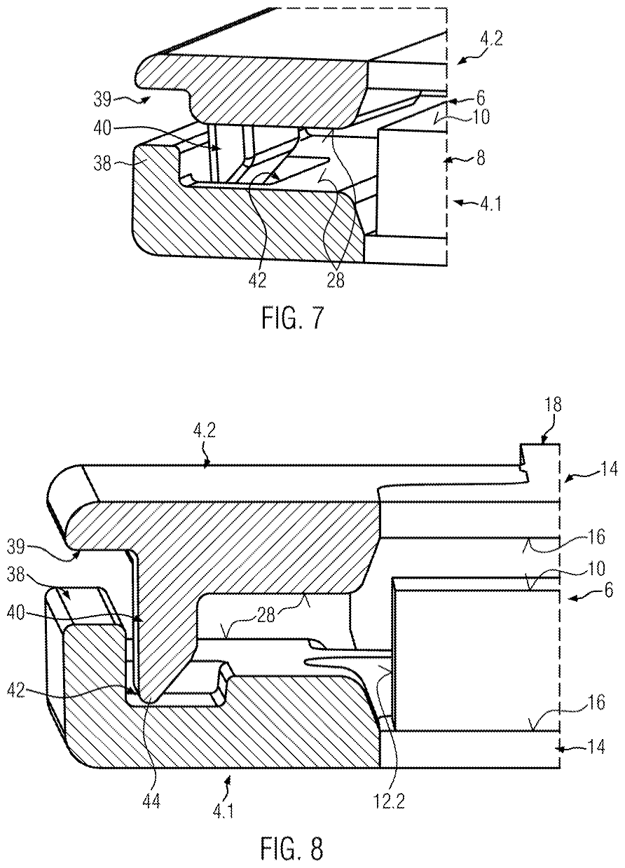

For the welding of the two frame segments 4.1/4.2, these have configurations which are illustrated in FIGS. 7 and 8. The frame segment 4.2 has a projecting pin 40 as connection segment. The lower frame segment 4.1 has a depression 42 formed to be adapted to the pin 40, which forms the other connection segment in the sense of the present invention. As FIG. 7 illustrates, the depression 42 is significantly larger than the base surface of the pin 40. The base surface of the pin 40 is rectangular. A conically projecting tip 44 of the pin 40 protrudes from this rectangular base surface of the pin 40. As FIGS. 7 and 8 illustrate, the depression 42 is significantly larger than the base surface of the pin both along the longitudinal beam 32 and transversely thereto. The depression 42 is dimensioned so as to be able to accommodate these conceivable amounts of melt that may be generated during ultrasonic welding by melting primarily the pin 40. The depression 42 accordingly forms a trough for accommodating conceivable amounts of melt during ultrasonic welding. As a result, the molten plastic mass remains within the respective depression during welding of the two frame segments 4.1/4.2.

A web 38 protruding from the lower frame segment 4.1 as shown in FIG. 7 or 8 limits the depression 42 on its outside and thus prevents the conceivable escape of melt on the outer circumferential surface of the frame 4.

In FIGS. 7 and 8, reference sign 38 characterizes a web that protrudes beyond the frame contact surface 28. Correspondingly, the edge surface of the upper frame segment 4.2 is recessed in the area of the web 38 relative to the associated frame contact surface 28 by a web holder 39. This web holder 39 extends uninterruptedly over the entire longitudinal beam 32. With FIGS. 7 and 8, it can be seen that the frame contact surfaces 28 define the parting plane, thus lie at half the height of the joined frame. The web 38 of the lower frame segment 4.1 according to FIGS. 7 and 8 protrudes through the parting plane and ends above the same. The web holder 39 of the upper frame segment 4.2 is recessed relative to the parting plane.

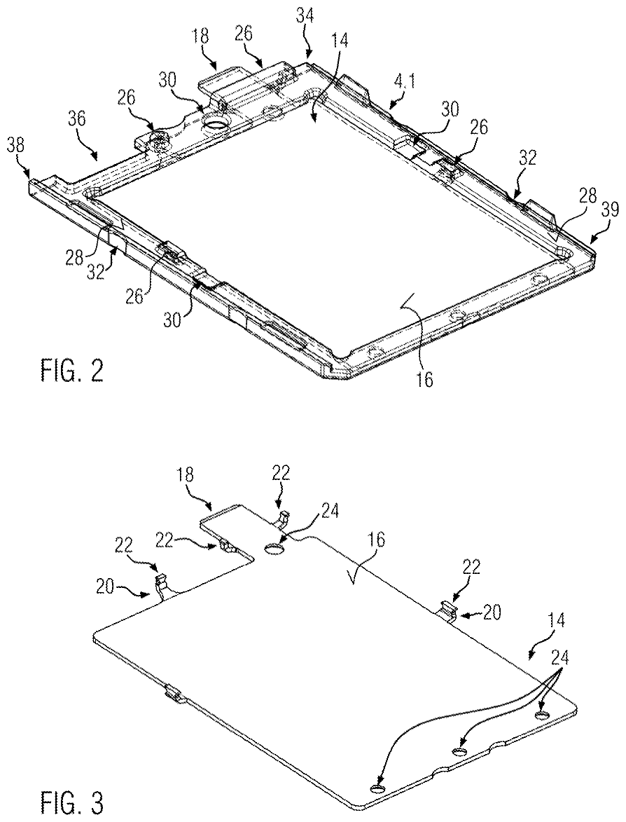

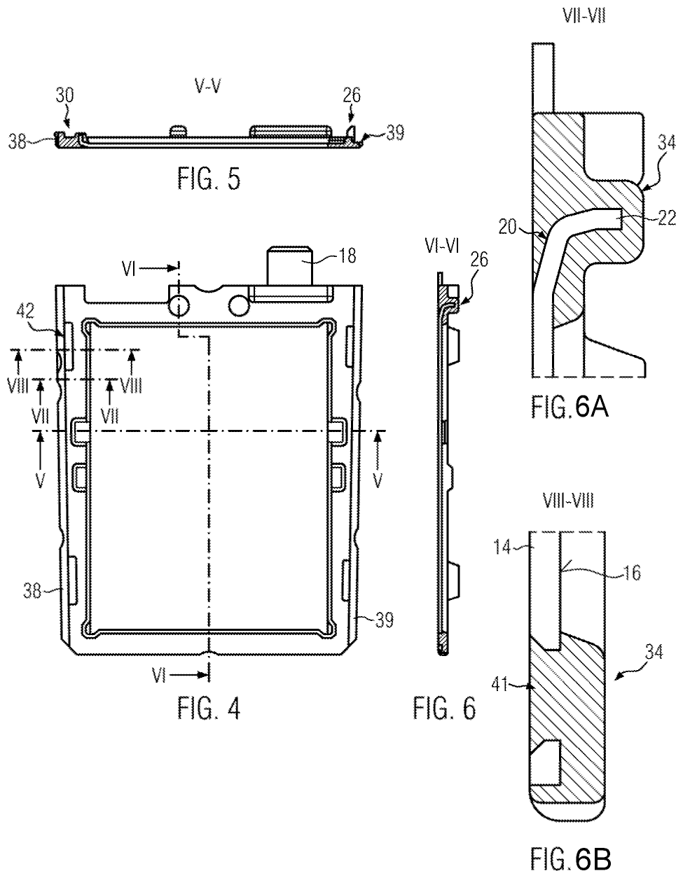

As FIGS. 2 and 4 convey, two depressions 42 are formed on one of the longitudinal beams 32 and two pins 40 are formed on the opposite longitudinal beam 32, which end on the outside in the web holder 39. The pins 40 and the depression 42 have an overall longitudinal extension that is small in relation to the overall extension of the longitudinal beam 32. The pins 40 may be slightly fin-shaped. In any case, they do not extend over the entire longitudinal extent of the longitudinal beam 32. The opposing cross beams 34 are free of connection segments for welding the two frame segments 4.1/4.2.

In the course of manufacturing the embodiment shown, two identical conductor elements are first formed by punching and bending a metal sheet. These are inserted into an injection mold and overmolded with the plastic forming the frame segments 4.1 or 4.2. In this process, the connecting projections 22 in particular are sealed in the plastic material. Two of the frame segments 4.1 shown in FIG. 2 are prepared in an identical manner for the PTC heating device 2.

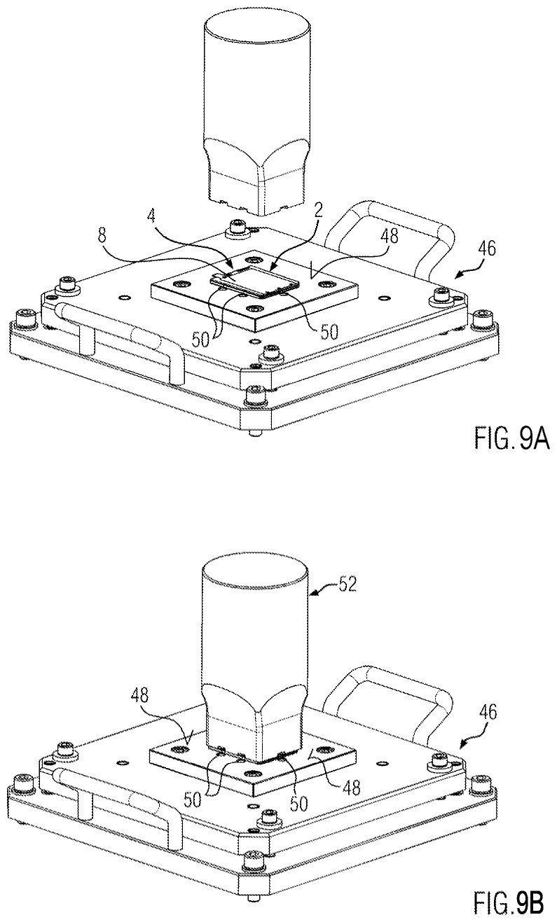

The lower frame segment 4.1 is introduced for assembly into an auxiliary assembly device, which is characterized by reference sign 46 in FIGS. 9A, 9B. This auxiliary assembly device 46 has a contact surface 48 which is protruded by limiting devices 50. The lower frame segment 4.1 is abutted against the contact surface 48. In this context, the frame segment 4.1 is laterally limited by the limiting devices 50 with a narrow tolerance. Thus, at the end of the insertion movement, the frame segment 4.1 is positioned exactly relative to the auxiliary assembly device 46.

The PTC element 8 is then placed on the inner contact surface 16 of the corresponding conductor element 14. As FIGS. 7 and 8 show, the PTC element 8 is slightly protruded from the free inner contact surface 16.

The other of the prepared frame segments 4.2 is then approached to the lower frame segment 4.1 on the auxiliary assembly device 46. The limiting devices 50 also allow good relative positioning of the two frame segments 4.1/4.2. The pins 40 then engage in the associated depressions 42. The state shown in FIGS. 7 and 8 is achieved.

Thereafter, a sonotrode characterized by reference sign 52 in FIGS. 9A/9B is approached to this layering from the two frame segments 4.1/4.2 and the PTC element 8. Ultrasound is applied to melt the pins 40 in the depressions 42. In this process, the tip 44 of the pin 40 melts first, not so much the surface of the depression 42. Due to a certain pressure applied by the sonotrode 52, the two frame segments 4.1/4.2 approach each other. The joining movement comes to an end when the inner contact surface 16 of the upper frame segment 4.2 is abutted against the upper main side surface 10 of the PTC element 8 in FIGS. 7 and 8. The movement of the sonotrode 52 is usually force-controlled. The higher resistance to progressive approach movement associated with the planar abutment of the conductor element 14 against the PTC element 8 is understood as a signal to stop the feed movement of the sonotrode 52.

After completion of the ultra-welding process, the melt solidifies. Excess melt from the two connection segments 40/42 is located inside the depression 42.

After the sonotrode has been moved back to the starting position shown in FIG. 9A, the completed PTC heating device can be removed.

1. A PTC heating device comprising:
a frame surrounding an accommodation space and including at least two frame segments;
at least one PTC element accommodated in the accommodation space; and
conductor elements which are connected to the PTC element in an electrically conductive manner and which enclose the PTC element between them, wherein each of the conductor elements is surrounded at least partially by at least one of the frame segments, and wherein the frame segments are ultrasonically welded together to enclose the PTC element in the accommodation space.

2. The PTC heating device according to claim 1, wherein the frame is formed by two frame segments, each of which surrounds conductor elements abutting against the PTC element and which forms interacting connection segments which are ultrasonically welded to each other.

3. The PTC heating device according to claim 2, wherein a depression, adapted to accommodate melt generated during welding, is formed adjacent to the connection segments on at least one of the frame segments.

4. The PTC heating device according to claim 2, wherein at least one of the frame segments has a pin that is associated with a depression on the other frame segment that holds the pin.

5. The PTC heating device according to claim 2, wherein, adjacent to the connection segments on at least one of the frame segments, a web is formed that is configured to prevent spillover of melt generated during welding over and beyond a contour of the frame.

6. The PTC heating device according to claim 1, wherein each of the conductor elements is sealed in the associated frame segment by overmolding a plastic forming the associated frame segment, and wherein the conductor elements comprise connecting webs protruding from an edge, which connecting webs are covered by positioning projections which are formed on one of the frame segments and which cooperate with associated positioning projection receptacles on the other of the frame segments.

7. The PTC heating device according to claim 6, wherein a contact tongue, protruding externally from the frame, is guided through the frame below one of the positioning projections.

8. A method of manufacturing a PTC heating device, comprising:
injection-molding frame segments from a plastic so as to form interacting connection segments on the frame segments;
connecting each of the frame segments to a conductor element;
introducing at least one PTC element between the frame segments;
approaching the frame segments to each other until the connection segments abut against each other;
melting the connection segments so as to allow the frame segments to further approach each other until the conductor elements abut against the PTC element.

9. The method according to claim 8, further comprising introducing one of the frame segments into an auxiliary assembly device, which auxiliary heating assembly has a contact surface supporting the frame segment on an underside thereof and which has lateral limiting devices for positioning the frame segment, and subsequently applying the other of the frame segments with enclosure of at least one PTC element between the frame segments, to one of the frame segments with guidance of the lateral limiting devices such that the connection segments provided on the frame segments interlock, and further comprising welding the connection segments to one another to produce the PTC heating device, and then removing the PTC heating device from the auxiliary assembly device.

10. A PTC heating device comprising:
a frame surrounding an accommodation space;
at least one PTC element accommodated in the accommodation space; and
conductor elements which are connected to the PTC element in an electrically conductive manner and which enclose the PTC element between them, wherein each of the conductor elements is sealed in the frame by overmolding a plastic forming the frame, and wherein the conductor elements comprise connecting webs protruding from an edge, which connecting webs are covered by positioning projections which are formed on a portion of the frame and which cooperate with associated positioning projection receptacles on another portion of the frame.

11. The PTC heating device according to claim 10, wherein a contact tongue, protruding externally from the frame, is guided through the frame below one of the positioning projections.

12. The PTC heating device according to claim 10, wherein the frame is formed from first and second frame segments that are ultrasonically welded together to enclose the PTC element in the accommodation space.
